(19) United States
(12) Patent Application Publication
(10) Pub. No.: US 2015/0171578 A1
(43) Pub. Date: Jun. 18, 2015

(54) BRAIDED WIRE CONNECTION FOR AN ELECTRONICS ASSEMBLY

(71) Applicant: DELPHI TECHNOLOGIES, INC., Troy, MI (US)

(72) Inventors: RALPH S. TAYLOR, NOBLESVILLE, IN (US); ROGER A. MOCK, KOKOMO, IN (US)

(73) Assignee: DELPHI TECHNOLOGIES, INC., Troy, MI (US)

(21) Appl. No.: 14/105,624

(22) Filed: Dec. 13, 2013

(51) Int. Cl. H01R 25/16

(52) U.S. Cl. CPC H01R 25/161

(57) ABSTRACT

An electrical assembly that includes an electronic device, a buss bar, and an electrical connection. The electronic device is operable to control electrical energy. The buss bar is configured to distribute electrical energy within the assembly. The electrical connection is configured to electrically interconnect the device and the buss bar. The electrical connection is formed of braided wire. Flat braided wire is advantageous as it is more flexible than a direct connection formed by a sheet-metal type lead frame, and provides for large contact areas capable of carrying higher currents than a wire-to-surface type contact made with a twisted wire that is generally round in shape.

### TECHNICAL FIELD OF INVENTION

This disclosure generally relates to an electronics assembly, and more particularly relates to using braided wire to make an electrical connection to an electrical device within the assembly.

### BACKGROUND OF INVENTION

It is known to form relatively thin sheet metal to make an electrical connection or electrical interconnect that provides for a large area electrical contact to an electrical device such as a power transistor. The power transistor may be used for controlling relatively large currents, for example, currents greater than ten Amperes (10 A). The sheet metal may be stamped and formed to provide stress relief. However, it has been observed that vibration and thermal cycling has caused cracking and failure of a sheet metal type electrical connection.

### SUMMARY OF THE INVENTION

In accordance with one embodiment, an electrical assembly is provided. The assembly includes an electronic device, a buss bar, and an electrical connection. The electronic device is operable to control electrical energy. The buss bar is configured to distribute electrical energy within the assembly. The electrical connection is configured to electrically interconnect the device and the buss bar. The electrical connection is formed of braided wire.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a perspective view of part of an electrical assembly in accordance with one embodiment;

FIG. 2 is a perspective view of part of an electrical assembly that incorporates the assembly shown in FIG. 1 in accordance with one embodiment;

FIG. 3 is an exploded perspective view of the assembly of FIG. 2 in accordance with one embodiment;

FIG. 4 is a close up perspective view of the assembly of FIG. 2 in accordance with one embodiment; and

FIG. 5 is a close up perspective view of an alternative feature for the assembly of FIG. 1 in accordance with one embodiment.

### DETAILED DESCRIPTION

To overcome the problems described above, braided wire replaces the known stamped and formed sheet metal or foil pieces used to make electrical interconnects or electrical connections in electrical assemblies. As used herein, the term braided wire includes any multiple strand wire where the strands are braided as opposed to simply twisted. As such, twisted multiple strand wire is specifically excluded from the term ‘braided wire’. Furthermore, the term braided wire is limited to a configuration that is generally characterized as flat or readily flattened, as opposed to being generally round as is the case for twisted wire. For example, when a braided wire is flattened, the width of the flattened braided wire will be at least twice the thickness of the un-flattened braided wire. An advantage of having flat braided wire is that braided wire is more flexible than a stamped metal contact which provides for a longer cycle life of a connection between a low coefficient of thermal expansion (CTE) object (e.g. substrate or silicon die) and a higher CTE metal type connection made of, for example, copper, copper alloy, or aluminum. Another advantage of having flat braided wire is that the area of contact with a surface made by the braided wire is readily made larger than is convenient with a round single strand or twisted wire, as will become apparent in the description of examples that follow. A large area contact is advantageous if relatively high electrical current (>10 A) is being conducted. Analysis indicates that a contact area of eight square-millimeters (8 sq-mm) should be sufficient for conducting 10 A.

An example of suitable braided wire is #2355 Tinned Copper Shielding Flat Braid available from Daburn Electronics & Cable, located in Dover, N.J., United States of America. Braided wire has been used with terminations applied to the ends of the braided wire as, for example, a ground strap connected to a vehicle battery, or to electrically interconnect metal body panels of a vehicle. Described herein is a new application for braided wire where direct connection is made by way of various metal-joining techniques such as soldering or welding.

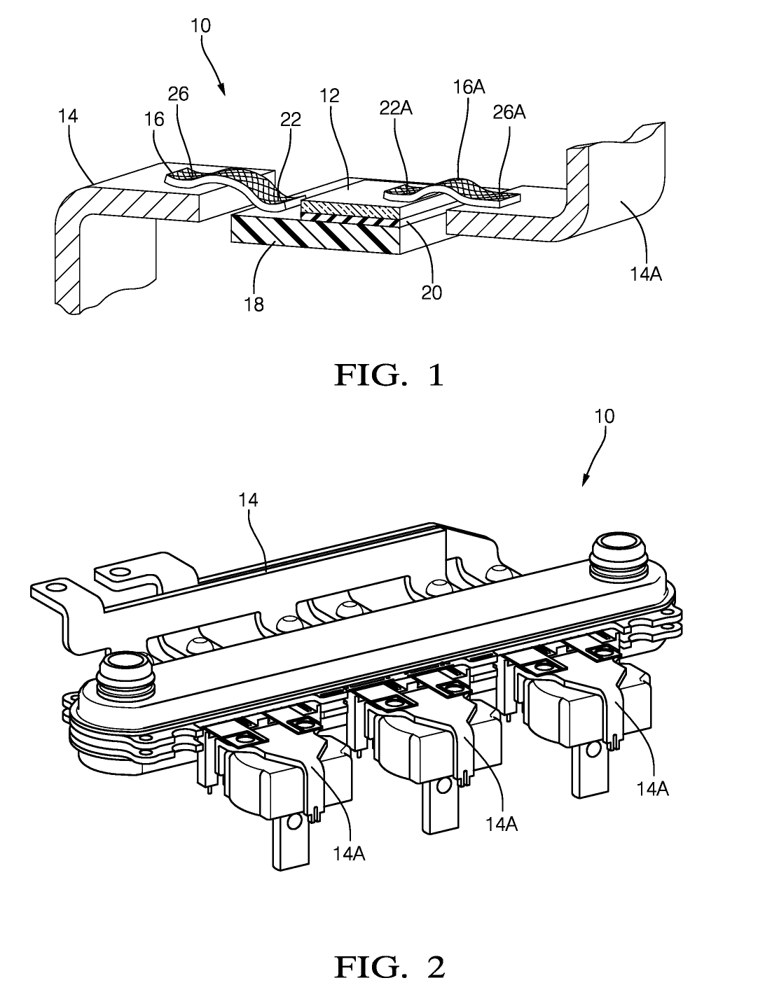

FIG. 1 illustrates a non-limiting example of an electrical assembly, hereafter referred to as the assembly 10. The assembly includes an electronic device such as a diode or transistor in die form, hereafter referred to as the device 12. In general, the device 12 is operable to control the flow of electrical energy. If the device 12 is a diode, electric current is allowed to flow in one direction. If the device 12 is a transistor, the device may be used to regulate the amount of electric current flowing through the device 12. While FIG. 1 illustrates only two apparent electrical connections to the device 12, it is recognized that a transistor would need a third electrical connection to be fully operable.

The assembly 10 includes a buss bar 14 configured to distribute electrical energy within the assembly 10. The buss bar 14 may be formed of copper, copper alloy, or, aluminum, and may be plated to prevent corrosion and promote metal joining by, for example soldering or welding. The buss bar 14 may be further configured to provide a connector means (not shown) for making electrical contact with a wire harness or connector so the assembly 10 can be installed into an electrical system of, for example, a vehicle or industrial machine. Alternatively, the buss bar 14 may be a conductor trace on a circuit board (not shown), where the circuit board may be formed of well-known materials such as FR-4 or Al2O3.

The assembly 10 includes an electrical connection, hereafter referred to as the connection 16. The connection 16 is generally configured to electrically interconnect the device 12 and the buss bar 14. The connection 16 is advantageously formed of braided wire in accordance with the definition of braided wire previously provided.

The assembly 10 may include a substrate 18 electrically interposed between the buss bar 14 and the device 12. In this non-limiting example, the connection 16 is connected to the substrate 18, and the device 12 is attached to or mounted upon the substrate 18. The substrate 18 may be advantageously formed of a ceramic material such as alumina (Al2O3) in order to match the thermal expansion characteristics of the device 12 when the device 12 is in die form. The substrate 18 may also include electrical conductors screen printed or otherwise applied to the surface of the substrate 18 for providing an electrical connection between the connection 16 and the device 12, as will be recognized by those in the art. The device 12 may be attached to the substrate by attachment material 20 such as solder or conductive epoxy, as will be recognized by those in the art.

A first end 22 of the connection 16 may be attached to the substrate 18 by any one of several metal joining techniques or connection processes such as, but not limited to, laser welding, resistance welding, ultrasonic welding, and soldering. It is recognized that some connection processes such as resistance welding may be improved by adding a metal pad (not shown) between the first end 22 and the substrate 18.

The assembly 10 may include another connection, hereafter referred to as the connection 16A, to electrically interconnect the device 12 to another buss bar, hereafter referred to as the buss bar 14A. In this example, a first end 22A of the connection 16A is illustrated as being in direct contact with the device 12. Those in the art will recognize that some connection processes such as resistance welding may not be preferable if the first end 22A is in contact with a thin-film type metalized surface of a silicon die that is device 12, and in such an instance soldering may be preferable. However, the assembly 10 may include a metal pad or heat spreader (not shown) interposed between the first end 22A and the device 12 so that connection processes that might otherwise damage a metalized surface of a silicon die can be used.

FIG. 5 illustrates a non-limiting example of the connection 16, 16A where the first end 22, 22A is configured to define a plurality of contact fingers 24. The contact fingers 24 may be advantageous when the connection 16, 16A has a different coefficient of thermal expansion than the substrate 18 and/or the device 12. By separating the width of the connection 16, 16A into the contact fingers 24 as illustrated, the contact area of each of the contact fingers 24 is reduced so the stress on the interface between the connection 16, 16A and the substrate 18 or the device 12 is reduced. The contact fingers 24 may be formed by, for example, first solder-dipping or coining the first end 22, 22A, and then cutting away portions of the first end 22, 22A to form the contact fingers 24 as shown. Alternatively, the strands of the braided wire that forms the connection 16, 16A may be combed and separated into distinct bundles, and then the ends of the individual bundles may be solder-dipped or coined to form the contact fingers. This alternative method may be more expensive, but may also provide a higher electrical current capability as this method does not cut away some of the strands.

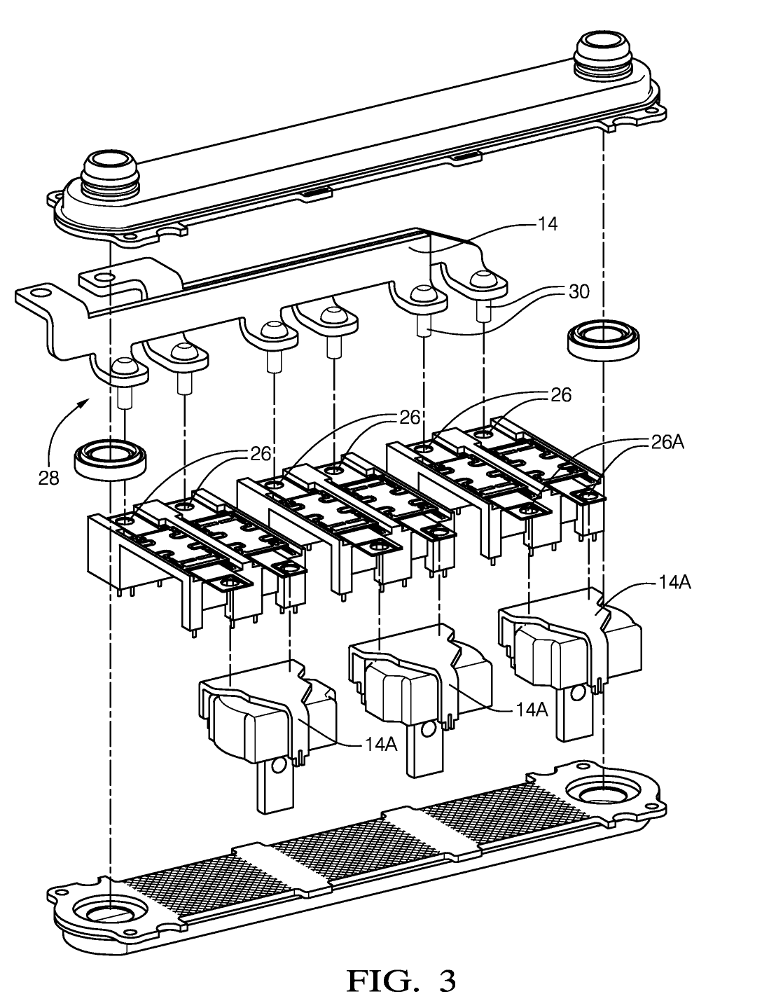

FIGS. 2 and 3 illustrate non-limiting examples of the assembly 10 that incorporates three of the arrangements shown in FIG. 1. By way of example and not limitation, a second end 26 of the connection 16 may be tinned (i.e. solder coated or solder dipped) and attached to the buss bar 14 by a clamping means 28 such as a threaded fastener 30 through the buss bar 14 that is threaded into a backing device (not shown) underneath the second end 26 (FIG. 3).

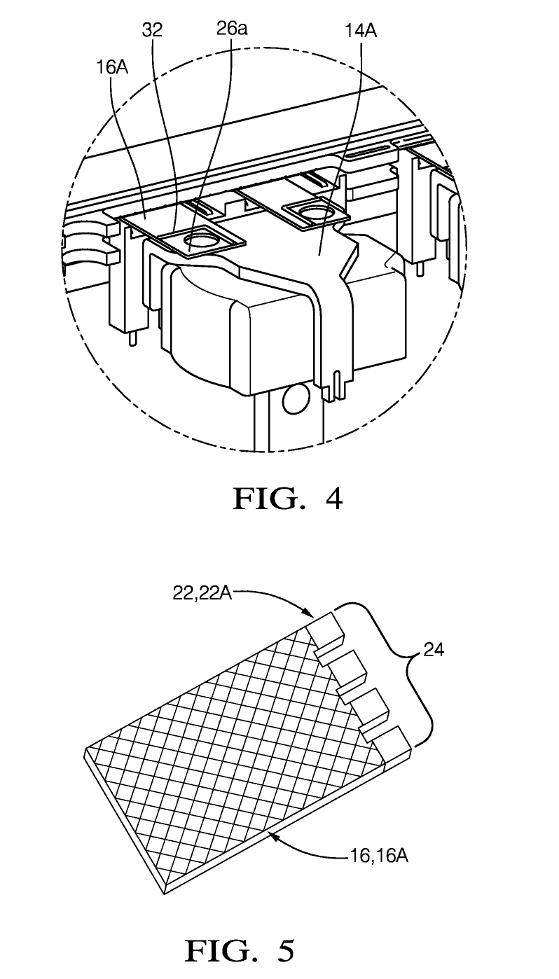

FIG. 4 illustrates a non-limiting example of a second end 26A of the connection 16A that is attached to the buss bar 14A by one of laser welding, resistance welding, ultrasonic welding, and soldering. If a welding process is used, a weld line 32 may be formed where the connection 16A is welded to the lead frame. The equipment for laser welding may be acquired from a variety of suppliers as described in various articles published by Industrial Laser Solutions (www.industrial-lasers.com) with offices in Nashua, N.H., USA. Various tools and methods for resistance welding stranded wire are described in Resistance Welding Stranded Copper Wire by David Steinmeier published in 2011. Equipment and processes for ultrasonic welding are available from Sonobond Ultrasonics, Inc. located in West Chester, Pa., USA. Various ways of soldering are well-known and include, but are not limited to, contact soldering (i.e. using a soldering iron), oven reflow soldering, and infrared reflow soldering.

Accordingly, an electrical assembly (the assembly 10) is provided that uses braided wire to interconnect, for example an electronic device (the device 12) to a lead frame 14. In applications exposed to large temperature variations and/or large variations in vibration and/or large variations in shock, braided wire provides for greater flexibility and longer life. A braided electrical conductor is a complex structure or pattern formed by intertwining, or interlacing, three or more strands of flexible wire into a whole. The size of a conductor, amount and type of metal, is determined by the amount of current that is required to flow thru that conductor. By using multiple smaller gauge wires to create stranded or braided lead frames that are the equivalent cross sectional area of a solid metal lead frame, for a given application, a more flexible electrical connection can be made.

While this invention has been described in terms of the preferred embodiments thereof, it is not intended to be so limited, but rather only to the extent set forth in the claims that follow.

We claim:

1. An electrical assembly, said assembly comprising:
an electronic device operable to control electrical energy;
a buss bar configured to distribute electrical energy within the assembly; and
an electrical connection configured to electrically interconnect the device and the buss bar, wherein the connection is formed of braided wire.

2. The assembly in accordance with claim 1, wherein the connection is suitable for conducting electrical current greater than ten Ampere (10 A).

3. The assembly in accordance with claim 1, wherein the assembly further comprises a substrate electrically interposed between the buss bar and the device, wherein the connection is connected to the substrate and the device is attached to the substrate.

4. The assembly in accordance with claim 3, wherein a first end of the connection is attached to the substrate by one of laser welding, resistance welding, ultrasonic welding, and soldering.

5. The assembly in accordance with claim 3, wherein the first end of the connection is configured to define a plurality of contact fingers.

6. The assembly in accordance with claim 1, wherein a second end of the connection is tinned and attached to the buss bar by a clamping means.

7. The assembly in accordance with claim 1, wherein a second end of the connection is attached to the buss bar by one of laser welding, resistance welding, ultrasonic welding, and soldering.
